(19) United States
(12) Patent Application Publication
(10) Pub. No.: US 2016/0349737 A1
(43) Pub. Date: Dec. 1, 2016

(54) MANUFACTURING EFFICIENCY OPTIMIZATION PLATFORM AND TOOL CONDITION MONITORING AND PREDICTION METHOD

(71) Applicant: CHUN-TAI YEN, TAIPEI CITY 103 (TW)

(72) Inventors: CHUN-TAI YEN, TAIPEI CITY 105 (TW); HUNG-AN KAO, TAIPEI CITY 114 (TW); CHIH-CHIANG KAO, TAOYUAN CITY 333 (TW)

(21) Appl. No.: 14/725,179

(22) Filed: May 29, 2015

(51) Int. Cl. G05B 19/4065; H04L 29/08

(52) U.S. Cl. CPC G05B 19/4065; H04L 67/10; G05B 2219/49001; G05B 2219/50204

(57) ABSTRACT

A platform and method for optimization of manufacturing efficiency by utilizing a service box to provide data obtained from sensors on production machines in order to perform tool condition monitoring and health assessment and predict power consumption trends. The sensor data is continuously monitored and analyzed. When power usage increases and vibration increases to a predetermined level the tool has become dull or worn to the point that the tool needs to be changed. The service box is coupled to sensors on a production machine. The service box receives appropriate data from the sensors and transfers the data to a cloud server in real-time. When it is determined that the tool needs to be replaced, notification is made and personnel replace the worn tool with a sharp tool.

### BACKGROUND OF THE INVENTION

Field of the Invention

The present invention relates to production systems. More specifically, the present invention discloses a platform and method for optimization of manufacturing efficiency by utilizing a service box to provide data obtained from sensors on production machines in order to perform cutting tool condition monitoring, health analysis, and power consumption prediction.

Description of the Prior Art

Manufacturing factories use various machines to produce products. The performance of the machines directly affects the cost of production and the profit available when selling the products. In order to improve machine performance traditional factories employ numerous technicians to maintain the machines.

Many conventional production facilities use machines with changeable tools such as drill bits, router bits, or other cutting tools that contact with material to cut, shape, or form the material into a product or part of a product.

After the tool has contacted the material several times, the tool begins to wear and as the tool continues to be used, the tool will dull and eventually wear out and need to be replaced.

However, conventional production systems do not have an effective method of determining when the tool should be replaced. Typically, factories replace a tool after producing a number of work pieces, working hours, or cutting area. However, this is based on workers or experts experience and the number setup is static and cannot reflect the real condition. Unfortunately, this method of tool replacement wastes material, material costs, and labor costs thereby increasing production costs and lowering manufacturing efficiency.

Therefore, there is need for an efficient method for optimizing manufacturing efficiency by using a platform to obtain data from production machines and utilizing intelligent tool condition monitoring, health analysis, and prediction tools on the data.

### SUMMARY OF THE INVENTION

To achieve these and other advantages and in order to overcome the disadvantages of the conventional method in accordance with the purpose of the invention as embodied and broadly described herein, the present invention provides a platform and method for optimizing manufacturing and increasing production efficiency by utilizing a service box to provide data obtained from sensors on production machines in order to perform tool condition monitoring, health analysis, and energy consumption prediction.

The present invention evaluates the reliability of a system within its life-cycle in order to proactively detect any upcoming failures and reduce risks. Knowing failure of certain equipment in advance and preventing it saves a significant amount of time and money while increasing the overall reliability and safety of both products and operations. External add-on sensors and controller signals are used for degradation monitoring and generating health information. A machine level health is generated by combination of the individual health of the critical sub-systems and their components.

The platform and method for optimizing manufacturing of the present invention comprises a service box, an application server, an agent server, and a cloud server.

The service box comprises a hardware box with electronic circuits, firmware, and software. The service box is coupled to sensors on a production machine. The service box requests and receives appropriate and accurate data from the sensors and transfers the data to the cloud server in real-time.

The present invention provides an efficient and effective method of determining when a changeable tool should be optimally replaced. Tool condition monitoring is provided by the service box obtaining sensor data from vibration sensors and power consumption sensors on the machine. The sensor data is continuously monitored and analyzed.

When power usage increases and vibration increases to a predetermined level the present invention determines that the tool has become dull or worn to the point that the tool needs to be changed. The appropriate personnel are notified and the tool is replaced with a sharp tool. Automatically identifying when the tool needs to be replaced allows the present invention to reduce wasted material and labor.

The application server comprises a plurality of analysis tools and management applications that are in development or have been completed by application designers and programmers and published on the application server. An agent server comprises a plurality of analysis tools and management tools that have been downloaded from the application server and available for direct use on the agent server. or for download to the cloud server. The analysis tools and management tools comprise applications that analyze sensor data and produce effective results to manage production efficiency and maximize overall equipment effectiveness. The analysis and management tools comprise, for example, tools for troubleshooting, production scheduling, quality control, health diagnosis, utilization magnifier, and energy monitoring. The cloud server comprises a plurality of analysis tools and management tools that have been provided by the agent server. The cloud server utilizes the analysis tools and management tools available on the agent server or available directly on the cloud server with the sensor data received in real-time from the service box.

The platform and method for optimizing manufacturing of the present invention further comprises a client device. The client device comprises a service dashboard for displaying an efficient visualization of the various results of the analysis tools and management tools provided by the cloud server. The user of the client device effectively monitors and administrates various aspects of production via the service dashboard and communicating with the cloud server.

As a result, the present invention effectively and efficiently monitors, analyzes, predicts, and manages production processes to optimize manufacturing by increasing machinery and production efficiency, monitoring tool condition, and predicting energy consumption to lower costs and increase profits.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is drawing illustrating a manufacturing efficiency optimization platform and tool condition monitoring method according to an embodiment of the present invention;

FIG. 2 is a flowchart illustrating a manufacturing efficiency optimization platform and tool condition monitoring method according to an embodiment of the present invention;

FIG. 3 is a flowchart illustrating a manufacturing efficiency optimization platform, tool condition monitoring, and power consumption prediction method according to an embodiment of the present invention;

FIG. 4A is a graph illustrating sensor signals;

FIG. 4B is a graph illustrating controller signals;

FIG. 5A is a graph illustrating power mean after averaging;

FIG. 5B is a graph illustrating selected tool condition monitoring features;

FIG. 6 is a graph illustrating health assessment value results and average consumed power per pass;

FIG. 7 a drawing illustrating multiple cloud servers of a manufacturing optimization platform and method according to an embodiment of the present invention; and

FIG. 8 is a drawing illustrating multiple service boxes of a manufacturing optimization platform and method according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

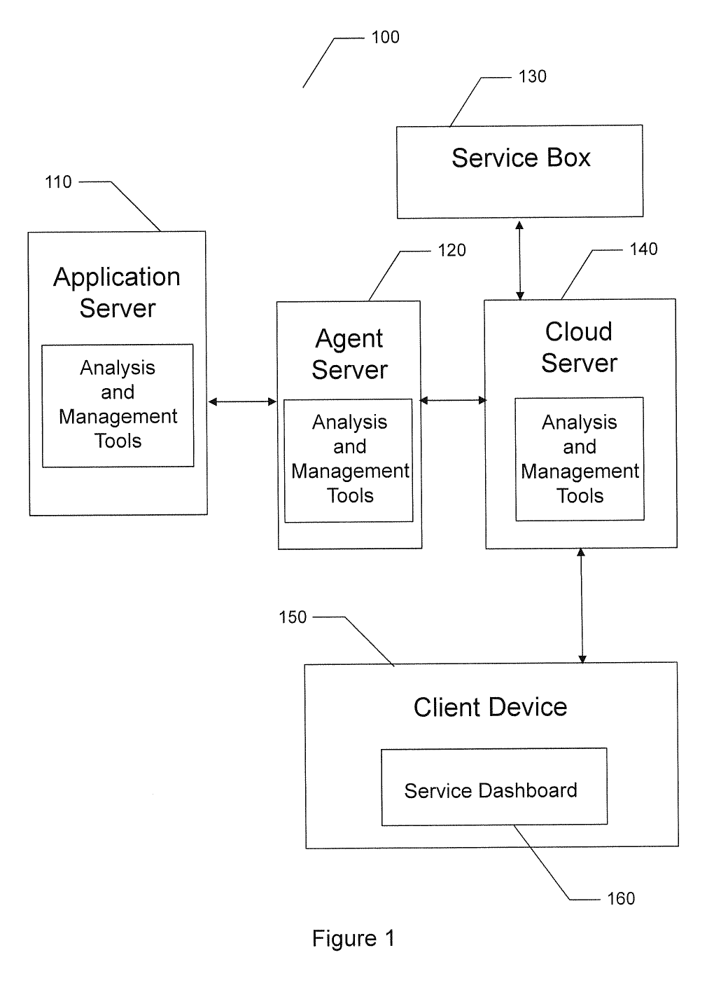

Referring to FIG. 1, the manufacturing efficiency optimization platform and tool condition monitoring method 100 comprises an application server 110, an agent server 120, a service box 130, a cloud server 140, and a client device 150.

The application server 110 connects with the agent server 120. The agent server 120 connects with the application server 110 and the cloud server 140. The service box 130 connects with the cloud server 140 and sensors of a production machine. The client device 150 connects with the cloud server 140. The cloud server connects with the agent server 120, the service box 130, and the client device 150.

The connections between the application server 110, the application server 120, the service box 130, the cloud server 14, and the client device 150 comprise a wireless network, a wired network, or a combination of wireless networks and wired networks.

The application server 110, the application server 120, the cloud server 14, and the client device 150 comprise servers, computers, tablets, smart phones, or other electronic devices capable of connecting to the platform 100.

The application server 110 comprises analysis and management tool applications that are still in development or have been completed and are available for distribution. Developers utilize the application server 110 while creating and programming the analysis and management tools. When the analysis and management tools are ready for distribution, the analysis and management tools are published on the application server 110 and the agent server 120 is notified.

The agent server 120 connects with the application server 110 to access and download the published analysis and management tools.

The analysis and management tools comprise, for example, tool condition monitoring and analysis, tools for data acquisition, health indicator extraction and selection, health assessment, visualization, performance prediction, quality analysis, projection, inventory, equipment effectiveness, monitoring and production, troubleshooting, production scheduling, quality control, health diagnosis, utilization magnifier, energy monitoring, knowledge management, data analysis, system management, customer management, remote monitoring, technical documents, service management, scheduling, and employee management.

Customized tools are available that have been requested by the cloud server 140 from the agent server 120 and developed by the application server 110 to meet specific needs required by the users of the cloud server 140.

The service box 130 comprises a hardware box with a microprocessor, a non-transitory memory, electronic circuits, firmware, software, and input/output connections. The service box 130 is coupled to sensors on a production machine. The service box 130 requests and receives appropriate and accurate data from the sensors and transfers the data to the cloud server 140 in real-time.

The sensors comprise such sensors as, for example, programmable logic controllers (PLC), computer numerical control (CNC) controllers, pressure sensors, power sensors, vibration sensors, temperature sensors, acoustic sensors, global positioning system (GPS) sensors, and enterprise resource planning (ERP)/manufacturing execution systems (MES) information technology (IT) systems.

The service box 130 is configurable to connect with the desired sensor(s) and receive the desired sensor data.

The cloud server 140 receives the sensor data from the service box 130 in real-time. The cloud server 140 is also capable of reconfiguring which sensors the service box 130 is connected to. The cloud server 140 comprises a microprocessor, a non-transitory memory. and a plurality of analysis tools and management tools that have been provided by the agent server 120. The cloud server 140 utilizes the analysis tools and management tools available on the agent server 120 or available directly on the cloud server 140 with the sensor data received in real-time from the service box 130. In an embodiment of the present invention the analysis and management tools are locally stored and executed on the cloud server 140. In another embodiment the analysis and management tools are stored and executed on the agent server 120.

The platform and method for optimizing manufacturing 100 of the present invention further comprises a client device 150. The client device 150 comprises a service dashboard 160 for displaying an efficient visualization of the various results of the analysis tools and management tools provided by the cloud server 140. The user of the client device 150 effectively monitors and administrates various aspects of production via the service dashboard 160 and communicating with the cloud server 140.

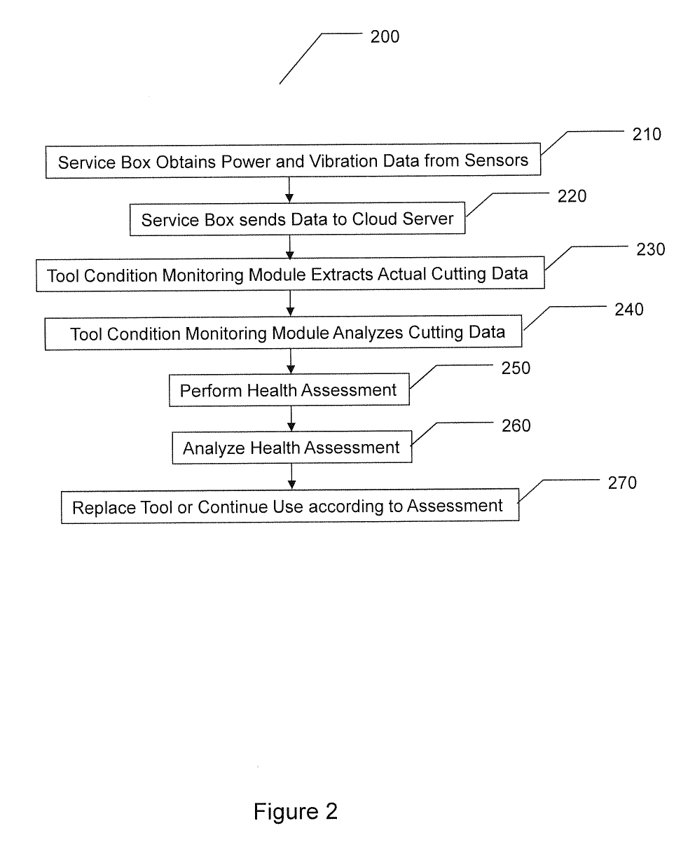

Refer to FIG. 2, which illustrates a manufacturing efficiency optimization platform and tool condition monitoring method according to an embodiment of the present invention.

By tracking failure features and using analytic tools to estimate the condition of the component, a major source of machine tool downtime can be avoided due to excessive wearing and breakage of cutting tools during machining operations. As a result, the present invention enhances productivity, produces and maintains better quality of machined parts, and reduces expenditures associated with automated manufacturing systems.

The present invention provides an efficient and effective method of determining when a changeable tool should be optimally replaced. Tool condition monitoring is provided by the service box obtaining sensor data from vibration sensors and power consumption sensors on the machine. The sensor data is continuously monitored and analyzed.

When power usage increases and vibration increases to a predetermined level the present invention determines that the tool has become dull or worn to the point that the tool needs to be changed. Automatically identifying when the tool needs to be replaced allows the present invention to reduce wasted material and labor.

From the machine tool, tool wear sensitive signals such as spindle power and vibration are collected and digitized by the service box. Selected controller signals are also recorded in order to properly segment within the sensor signals. Both data streams are then sent to the cloud server. A segmenting module is then initiated to remove leading and trailing samples that are not significant to the actual cutting operation. The remaining data segments are then stored for processing by the tool condition monitoring module which produces a health state estimate for a given test data.

In the embodiment illustrated in FIG. 2, the manufacturing efficiency optimization platform and tool condition monitoring method 200 of the present invention comprises the service box obtaining power and vibration data from the appropriate sensors on the machine or tool in Step 210. In addition to the power and vibration data, other control signals are obtained from sensors by the service box. In Step 220, the service box sends the obtained data to the cloud server.

In Step 230, a tool condition monitoring module of the analysis and management tools extracts the cutting data where the tool was actually contacting production material and cutting from the data where the tool was idle or resetting and not contacting production material. The tool condition monitoring module analyzes the extracted cutting data in Step 240. In Step 250, the tool condition monitoring module performs a health assessment of the tool from the analysis of the extracted cutting data. In Step 260, the health assessment is analyzed to determine the health condition of the tool. In Step 270, if the analysis of the health assessment determines that the tool is worn and should be replaced, the tool is replaced or if the analysis of the health assessment determines that the tool can still be used production continues using the tool.

In an embodiment of the present invention, the service box or the cloud server notifies appropriate personnel such as, for example, an engineer, a technician, or a machine operator. When notified the personnel exchanges the dull tool with a sharp tool and production quickly resumes.

In an embodiment of the present invention, the service box or the cloud server notifies appropriate personnel just prior to the tool needing to be changed. This allows personnel to retrieve a new tool in advance to save time. The personnel are notified again once the tool needs to be changed.

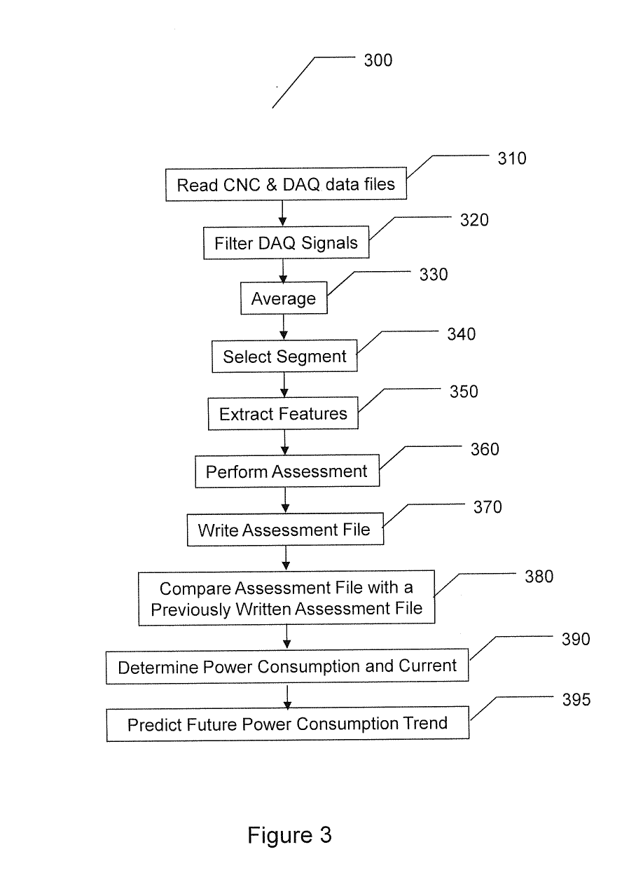

Refer to FIG. 3, which is a flowchart illustrating a manufacturing efficiency optimization platform, tool condition monitoring, and power consumption prediction method 300 according to an embodiment of the present invention.

When the tool condition monitoring module is triggered, the sensor data and the control data that the service box sends to the cloud server are read in Step 310. This data comprises, for example, computer numerical control (CNC) data, vibration data, power usage data, current data, and data acquisition (DAQ) data. In Step 320, the data is filtered and an averaging process is performed in Step 330. In Step 340, a segment is selected and appropriate features are extracted in Step 350. In Step 360, a health assessment is performed and a health assessment file is written in Step 370.

The present invention further comprises a prediction module for predicting future power consumption. By predicting power consumption, energy usage overcharges and power limits can be avoided, manufacturing facilities can more effectively schedule production, and tool makers can improve tooling.

In Step 380, the health assessment file is compared with a previously written assessment file. For example, the currently written health assessment file is compared with a previously written health assessment file or with a plurality of previously written health assessment files.

Next in Step 390, the power consumption and current are determined. And the future power consumption trend is predicted in Step 395.

When the tool condition monitoring module is triggered, the module automatically searches for the appropriate data file or data files. The file paths indicted in this file are then located and the associated files are parsed. The resulting signal or data undergoes a series of processes wherein features are extracted from a stable portion of the signal. A stable portion is defined as the duration of the data wherein the cutting tool is actually engaged onto the workpiece. The power data undergoes a averaging process, after which, the stable part of the segment is identified using a means method. Time location of the stable portion is used to isolate the equivalent segment in the vibration data. Features are then computed from the stable portion from both the vibration and power signals. Summary statistics such as average, standard deviation, minimum and maximum values are derived.

The selected features are then fed to a health assessment technique which uses a Euclidean metric.

The health assessment results with a normalized health assessment value which starts out high and as the cutting tool is continuously used, the degradation manifests as an almost monotonic decrease in the health value. Eventually, the tool gets replaced when the health assessment value reaches a value just below a predetermined value such as, for example, 0.5. The health assessment value when the tool needs to be replaced is relatively similar to the cutting tests performed under similar machining conditions and parameters.

When the tool is determined to be dull, appropriate personnel are notified via the service box or the cloud server and the personnel changes the dull tool for a sharp tool.

The manufacturing efficiency optimization platform and tool condition monitoring and prediction method of the present invention provides real-time monitoring of tool condition and allows manufacturers to easily understand the condition of their tools. The prediction module further allows manufacturers to use power consumption trends to improve scheduling and avoid power limitations.

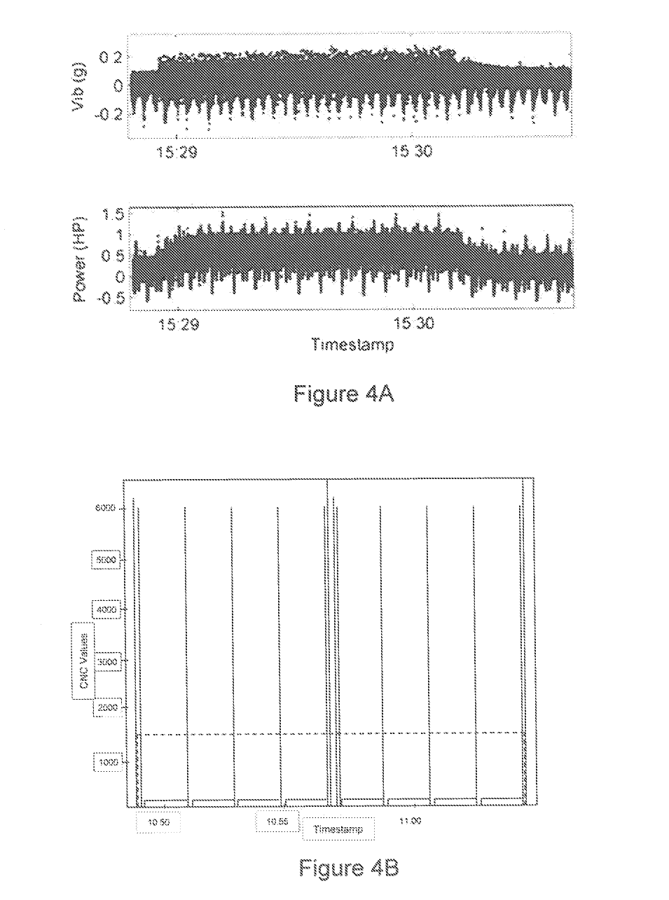

For reference according to the above description, refer to FIG. 4A, which is a graph illustrating sensor signals and to FIG. 4B, which is a graph illustrating controller signals. In FIG. 4A the vibration data is shown on top and the power data is shown on bottom.

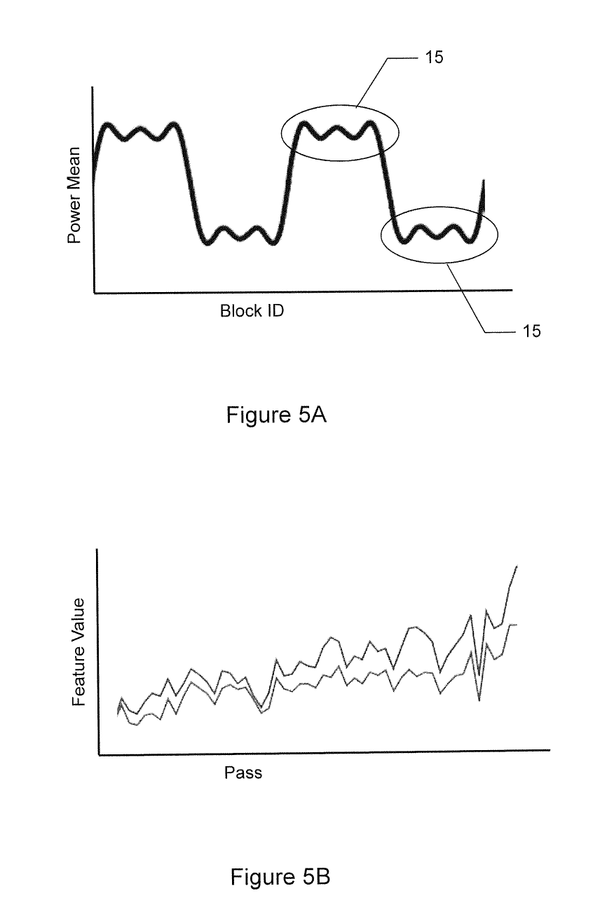

Also, refer to FIG. 5A, which is a graph illustrating power mean after averaging. The stable portion of the signal 15 is illustrated in the plateau at the highest or lowest values of the power mean. Time location of the stable portion is used to isolate the equivalent segment in the vibration data. Also, refer to FIG. 5B, which is a graph illustrating selected tool condition monitoring features. Features are computed from the stable portion from both the vibration and power signals.

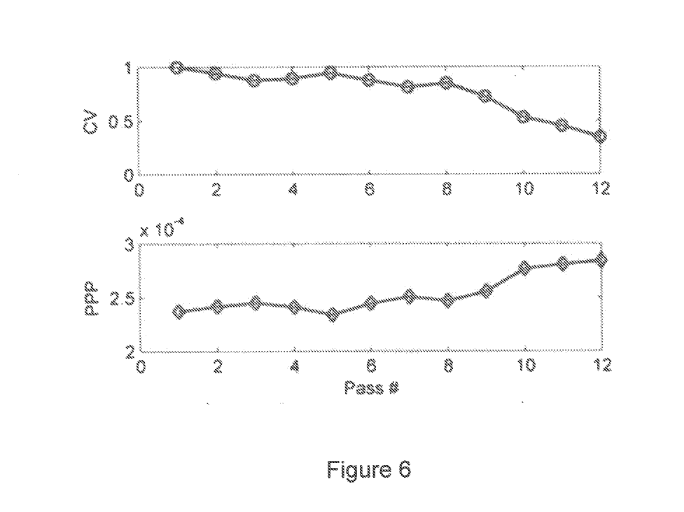

Refer to FIG. 6, which is a graph illustrating health assessment results and average consumed power per pass. The health assessment is shown on top and the power consumption is on bottom. As shown in the figure, the power consumed increases with tool wear. The health assessment decreasing and the power consumed increasing indicates that the tool is wearing out. When the health assessment value has decrease to a predetermined point, the tool is replaced.

The manufacturing efficiency optimization platform and tool condition monitoring method of the present invention further comprises creating analysis and management tools. Application developers utilize the application server to create and develop the analysis and management tools that are used within the platform. The analysis and management tools in development or are finished are stored on the application server. When the tools are complete, the tools are published on the application server and the agent server is notified that the analysis and management tool is ready for distribution. During development and when published the analysis and management tools are stored on the application server. After the agent server has been notified that the application and management tools have been published, the application and management tools are downloaded from the application server to the agent server. The cloud server is notified of the new or updated versions of the analysis and management tools.

The analysis and management tools on the agent server are provided to the cloud server. In an embodiment of the present invention the analysis and management tools are downloaded to the cloud server automatically. In another embodiment of the present invention the analysis and management tools are downloaded as needed or desired by the cloud server.

The service box coupled to the machinery sensor or sensors receives appropriate sensor data from the sensor(s). This sensor data comprises, for example, power consumption, temperature, viscosity, noise level, vibration, material quantity or volume, product count, etc. The service box transmits the sensor data to the cloud server in real-time and the transmitted sensor data is received by the cloud server.

The cloud server utilizes the analysis and management tools on the sensor data. For example, when the sensor data comprises the current temperature of the mold on the machine, the analysis and management tool tracks the temperature and produces a record or history of the temperature, produces an alarm if the temperature is too high or too low, and other useful analysis. The results from the analysis and management tools on the sensor data are provided to the client device by the cloud server. In an embodiment of the present invention the results are transmitted to the client device automatically. In another embodiment the results are provided upon a request from the client device. The results are displayed in the service dashboard on the client device.

The service dashboard on the client device provides a means for a user to access analysis results and data provided by the cloud server. The service dashboard comprises, for example, a display of available tools, reports, graphs, charts, maps, histories, logs, schedules, quantities, inventories, documents, orders, or projections.

The service dashboard displays icons of available tools and data accessible to the user of the client device. Clicking on one of the icons brings up a visualization of the selected icon. For example, if the user selects an icon for production quantity the service dashboard displays a graph of the current production volume as well as showing the past volume history. In this way, the user can easily see valuable information in real-time rather than reading through a printed report.

In an embodiment the service dashboard is configurable for individual users and only displays appropriate tools and data for each user. For example, quality assurance personnel do not see financial, ordering, or shipping information. This prevents information overload and confusion by simplifying the use of the platform. In an embodiment the service dashboard is configured to display appropriate data in real-time on the client device. For example, a worker on the on the production floor will see a real-time graph of machine performance on their client device and not be confused by unnecessary data.

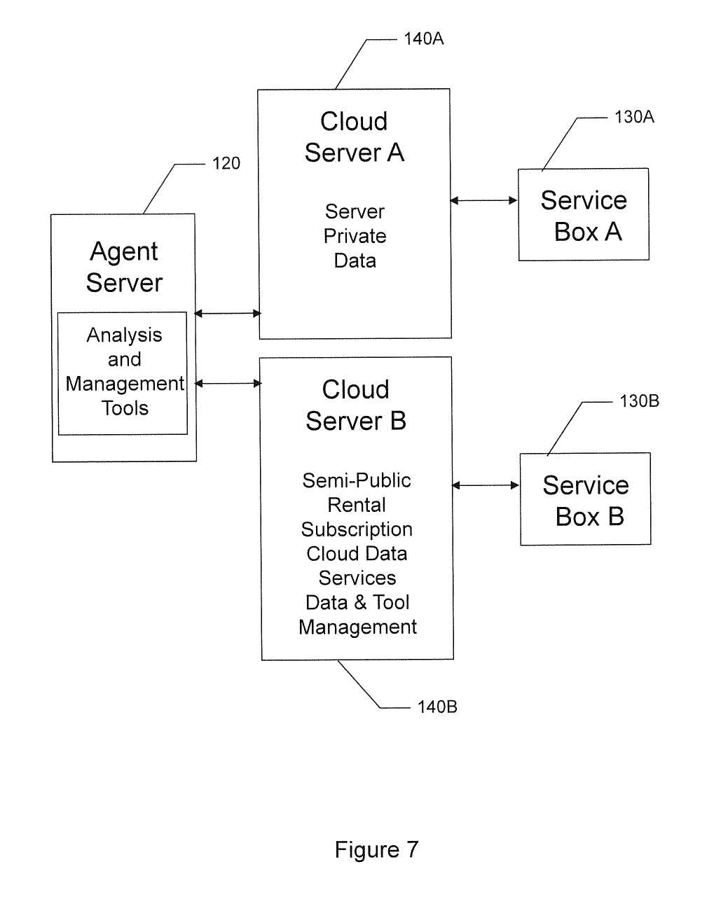

Refer to FIG. 7. The present invention provides flexibility for the client by offering various configurations for the cloud server and the platform service. In the embodiment illustrated in FIG. 7, a plurality of cloud servers connect to the agent server 120. Cloud server A 140A connects with service box A 130A and cloud server B connects with service box B 130B and both cloud servers 140A 140B connect to the same server agent 120.

Cloud server A 140A is configured as a private cloud server. A private cloud server comprises private data that is only accessible to the client. Cloud server A 140A connects to the agent server to download analysis and management tools. All data, for example, sensor data, production data, analysis data, and management data are kept on cloud server A 140A and not publicly available. A private cloud server such as cloud server A 140A provides a high level of security for sensitive manufacturing data for the client.

Cloud server B 140B is configured as a semi-public cloud server where some or all of the data on cloud server B 140B is available to the service agent 120. Service agent 120 provides cloud data services as well as analysis and management tool management services for cloud server B 140B. For example, the service agent 120 routinely updates the analysis and management tools, provides access to new tools, performs analysis on production data, and maintains cloud server B 140B, A semi-public cloud server such as cloud server B 140B is more economical to maintain to smaller companies or clients without a dedicated technical support team.

In an embodiment of the present invention the analysis and management tools are subscription based. The client can choose which analysis and management tools they need and pay for use of the tools rather than purchasing the tools. This allows the client to avoid paying for tools they may not need. This further lowers the cost of establishing the platform of the present invention.

In an embodiment of the present invention the analysis and management tools are purchased individually with a varying cost depending on complexity of the tool.

In an embodiment of the present invention the analysis and management tools are rented. This allows the client to return the tool when they have finished using or no longer need the tool. For example, if the tool is an inventory efficiency tool that analyzes the efficiency annually, the client can rent the tool once a year for a short period and then return the tool.

In an embodiment of the present invention the service box is rented to the client. This provides flexibility in increasing or decreasing the number of service boxes as machines are added or removed from the production facility. By renting the service boxes, cost of the platform of the present invention can be easily controlled by the client and initial cost is lowered compared with purchasing the service boxes initially.

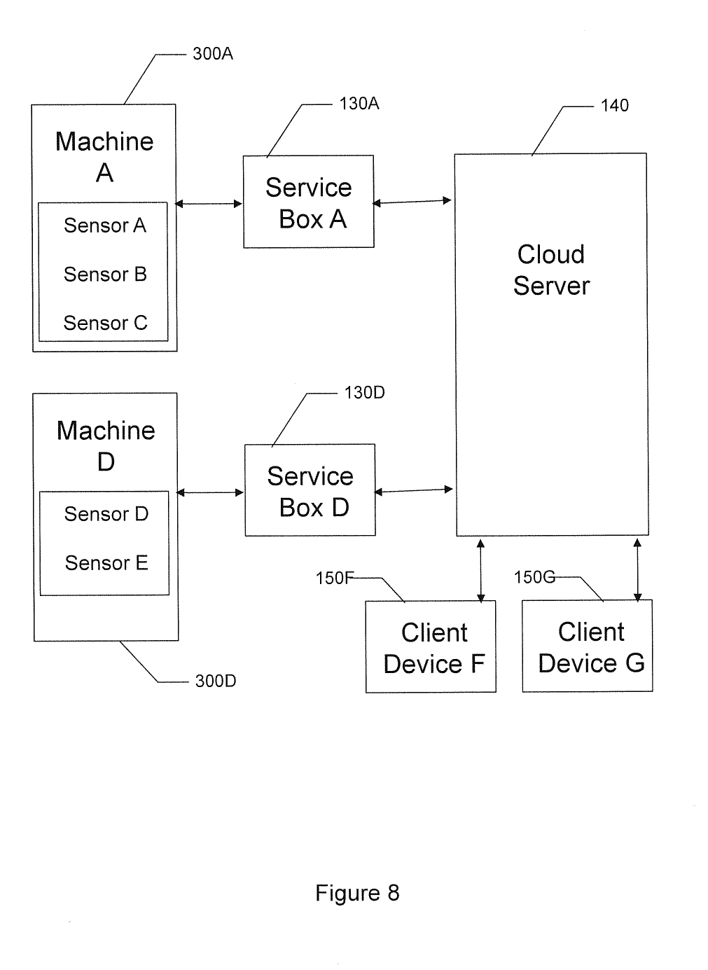

Refer to FIG. 8. In the embodiment illustrated in FIG. 8 a plurality of service boxes connect to the same cloud server. Service box A 130A connects with machine A 300A and receives sensor data from sensor A, sensor B, and sensor C of machine A 300A. Service box A 130A transmits the received sensor data to the cloud server 140. Service box D 130D connects with machine D 300D and receives sensor data from sensor D and sensor E of machine D 300D. Service box D 130A transmits the received sensor data to the cloud server 140.

The cloud server 140 connects with a plurality of client devices (client device F 150F and client device G 150G). Data such as, for example, sensor data, analysis data, management data, and machine data from both machine A 300A and machine D 300D is made available to both client device F 150F and client device G 150G or either depending on access privileges.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A manufacturing efficiency optimization platform with tool condition monitoring method comprising:
obtaining data from sensors on a machine by a service box;
sending obtained data to a cloud server;
extracting data where a tool on the machine was contacting a workpiece from the obtained data;
analyzing extracted data;
performing a health assessment of the tool from analysis of the extracted data;
analyzing the health assessment to determine health condition of the tool;
replacing the tool if the health assessment indicates that the tool needs to be replaced; and
continuing production using the tool if the health assessment indicates that the tool can still be used.

2. The manufacturing efficiency optimization platform with tool condition monitoring method of claim 1, where the obtained data comprises power consumption data and vibration data.

3. The manufacturing efficiency optimization platform with tool condition monitoring method of claim 2, where the obtained data further comprises computer numerical control (CNC) data and data acquisition (DAQ) data.

4. The manufacturing efficiency optimization platform with tool condition monitoring method of claim 1, further comprising:
determining a health assessment value for the tool from the health assessment; and
determining that the tool needs to be replaced when the health assessment value reaches a predetermined value.

5. The manufacturing efficiency optimization platform with tool condition monitoring method of claim 1, further comprising:
comparing the health assessment with a previous health assessment;
determining power consumption; and
predicting future power consumption.

6. The manufacturing efficiency optimization platform with tool condition monitoring method of claim 1, further comprising:
notifying personnel when the tool needs to be replaced.

7. The manufacturing efficiency optimization platform with tool condition monitoring method of claim 1, further comprising:
notifying personnel of impending tool change prior to the tool needing to be replaced.

8. A manufacturing efficiency optimization platform with tool condition monitoring method comprising:
obtaining sensor data and control data from a production machine by a service box;
sending the sensor data and the control data by the service box to a cloud server;
filtering the sensor data and the control data;
performing an averaging process on filtered data;
selecting a segment from results of the averaging process;
extracting features from the segment;
performing a health assessment; and
determining a health assessment value of condition of a tool on the production machine.

9. The manufacturing efficiency optimization platform with tool condition monitoring method of claim 8, where the sensor data and control data comprise vibration data and power consumption data.

10. The manufacturing efficiency optimization platform with tool condition monitoring method of claim 9, where the sensor data and control data further comprise computer numerical control (CNC) data and data acquisition (DAQ) data.

11. The manufacturing efficiency optimization platform with tool condition monitoring method of claim 8, further comprising:
determining that the tool needs to be replaced when the health assessment value reaches a predetermined value.

12. The manufacturing efficiency optimization platform with tool condition monitoring method of claim 8, further comprising:
comparing the health assessment with a previous health assessment;
determining power consumption; and
predicting future power consumption.

13. The manufacturing efficiency optimization platform with tool condition monitoring method of claim 8, further comprising:
comparing the health assessment with a plurality of previous health assessments;
determining power consumptions; and
predicting future power consumption trends.

14. The manufacturing efficiency optimization platform with tool condition monitoring method of claim 8, further comprising:
replacing the tool when the health assessment value reaches a predetermined value.

15. The manufacturing efficiency optimization platform with tool condition monitoring method of claim 14, further comprising:
notifying personnel when the tool needs to be replaced.

16. The manufacturing efficiency optimization platform with tool condition monitoring method of claim 14, further comprising:
notifying personnel of impending tool change prior to the tool needing to be replaced.

17. A manufacturing efficiency optimization platform with tool condition monitoring method comprising:
obtaining vibration data, power consumption data, and control data from sensors on a production machine by a service box;
sending the vibration data, power consumption data, and control data by the service box to a cloud server;
filtering the vibration data, power consumption data, and control data;
performing an averaging process on filtered data;
selecting a segment from results of the averaging process, the segment comprising when a tool on the production machine contacts a workpiece;
extracting features from the segment;
performing a health assessment;
determining a health assessment value of condition of the tool on the production machine; and
replacing the tool when the health assessment value reaches a predetermined value.

18. The manufacturing efficiency optimization platform with tool condition monitoring method of claim 17, further comprising:
comparing the health assessment with a previous health assessment;
determining power consumption; and
predicting future power consumption.

19. The manufacturing efficiency optimization platform with tool condition monitoring method of claim 17, further comprising obtaining and sending computer numerical control (CNC) data and data acquisition (DAQ) data by the service box.

20. The manufacturing efficiency optimization platform with tool condition monitoring method of claim 17, wherein as the vibration data indicates vibration is increasing and the power consumption data indicates power consumption is increasing the health assessment value decreases and indicates tool wear.
